(19) United States
(12) Patent Application Publication
(10) Pub. No.: US 2014/0351739 A1
(43) Pub. Date: Nov. 27, 2014

(54) METHOD FOR GENERATING AT LEAST ONE PART OF A VIRTUAL KEYPAD, CORRESPONDING ELECTRONIC TERMINAL AND COMPUTER PROGRAM PRODUCT

(71) Applicant: Compagnie Industrielle et Financiere D'Ingenierie "Ingenico", Paris (FR)

(72) Inventor: Michel Leger, Saint Germain en Laye (FR)

(21) Appl. No.: 14/283,964

(22) Filed: May 21, 2014

(30) Foreign Application Priority Data
May 21, 2013 (FR) 1354545

(51) Int. Cl. G06F 3/0488

(52) U.S. Cl. CPC G06F 3/04886
USPC 715/773

(57) ABSTRACT

A method is provided for generating at least one part of a virtual keypad on a touch screen of an electronic terminal. The method includes, prior to displaying the virtual keypad on the touch screen, computing a random graphic representation of the virtual keypad delivering at least one parameter representing a random zone of occupancy of the virtual keypad on the touch screen.

### FIELD OF THE INVENTION

The field of the invention is that of terminals comprising a touch screen.

More specifically, the invention pertains to such portable terminals and their improvement in order to combat the misuse of such terminals by malicious third parties.

In particular, the invention can be applied to terminals enabling electronic payment.

### PRIOR ART

There are increasing numbers of terminals known today that comprise touch screens, such as mobile telephones, personal digital assistants (PDAs), laptops, automatic cash dispensers, or again business cash registers.

There also exist electronic payment terminals comprising touch screens. In this case, such a touch screen can be for example a virtual keypad for validating a confidential code or the amount of a transaction.

One drawback of these electronic terminals lies however in the fact that such a touch screen can keep a trace of the entry made by a user, especially the entry of a confidential code or of piece of information carried on a bank card. For example, the screen can have finger traces at the places corresponding to the designation of a particular digit on a virtual keypad (for example because the terminal has been cleaned just before the entry of the secret code or because the screen or the tip of a stylus is coated with a reflective product for example).

These traces are particularly marked when the terminal is a payment terminal regularly used by a same user, for example when this user uses his own mobile phone (for example a Smartphone) having an electronic payment application.

Because of this, it is easy for a malicious third party having access to the payment terminal to identify the digits entered. All that remains for him thereafter is to try out the different permutations of the digits identified in order to arrive at the confidential code. For a four-digit code, this corresponds to a relatively limited number of combinations (24, 12, 6, 4 or even one depending on whether the digits are repeated or not). This attempt can furthermore be facilitated by observing the movement of the user's fingers when he enters his code. Indeed, this can give an indication on the order of the sequence of the digits composed.

Prior-art solutions consist in displaying the digits of the keyboard with a random arrangement within the number pad (where the 5 succeeds the 1 and precedes the 8 for example). However, the random succession of the keys confuses the user who is habituated to a certain sequencing of the movements of the hand when he uses a physical keypad, to the extent that he momentarily forgets his secret code.

There is therefore a need for new portable terminals comprising touch screens that are both secured and ergonomic.

### SUMMARY OF THE INVENTION

The invention proposes a novel solution to this problem in the form of a method for generating at least one part of a virtual keypad on a touch screen of an electronic terminal.

According to the invention, said method comprises, prior to a step for displaying said virtual keypad on said touch screen, a step for computing a random graphic representation of said virtual keypad delivering at least one parameter representing a random zone of occupancy of said virtual keypad on said touch screen.

Such a virtual keypad can for example be intended for the entry of sensitive data such as the entry of a confidential code or an amount of a transaction.

In making the display zone of the keypad on the screen vary randomly, the solution of the invention, in at least one of its embodiments, makes it possible to obtain variations in the location of the keys of the keypad on the screen so as to prevent a malicious third party from determining which keys have been actuated by observing the screen, and thus guessing a code entered by a user on this keypad.

According to one particular characteristic of the invention, said step for computing comprises a step for memorizing said computed random graphic representation.

According to one particular characteristic of the invention, said step for computing comprises a step for comparing said computed random graphic representation with at least one previously memorized graphic representation.

Such an embodiment makes it possible, because of the random character of the computation, to prevent the virtual keypad from occupying a zone of the screen that has already been occupied by a previous representation of the virtual keypad. For example, the invention can make sure especially that the zone occupied by said keypad on said touch screen always varies during the two consecutive entries made on said touch screen.

According to one particular characteristic of the invention, said step for computing takes account of at least one criterion of relative position of the alphanumeric keys of said random graphic representation of said virtual keypad.

According to one particular characteristic of the invention, said criterion consists in keeping the relative position of at least one part of the alphanumeric keys of said random graphic representation unchanged between two successive displays of said virtual keypad.

Such an embodiment offers the advantage of presenting the user with a more ergonomic entry interface inasmuch as the user can make a mechanical and repetitive motion for the entry of his secret code since the sequencing of the keys that can be used to compose this code remains constant. At the same time it secures the entry because of the shifting of all the keys by means of a modification of the location on the screen or the shape of the keyboard.

According to one particular characteristic of the invention, said criterion consists in modifying the relative position of at least one part of the alphanumeric keys of said random graphic representation between two successive displays of said virtual keyboard.

Such an embodiment makes it possible to add a second security to the security provided by the random modification of the keyboard. This second security is provided by the variation, possibly also random, of the position of the keys relative to one another on the keypad. This second security makes it possible especially to prevent an interception of the code entered by means of a video viewing and/or recording means for recording the motion of the hand made during the entry of a code.

In certain embodiments of the invention, the numerical keys of the keypad can keep relatively unchanged positions while the other keys of the keypad (especially the keys enabling validation, cancellation or correction of an entry) can be laid out randomly in the space left free on the keypad by the numerical keys.

According to one particular characteristic of the invention, said at least one parameter representing a random zone of occupancy of said virtual keypad on said touch screen belongs to the group comprising:

a dimension of said virtual keypad;

a location of said virtual keypad on said screen;

a shape of the contours of said virtual keypad;

an orientation of said virtual keypad relative to said screen.

Such an embodiment makes it possible, by changing the shape of the keypad, for example by modifying at least one of its dimensions (for example its width) or its location on the screen or again by a change in shape of the contours of the keypad with a zoom effect for example, to effect a variation in the location of the keys.

According to another aspect, the invention pertains to a computer program product comprising a program code instructions for implementing the above-mentioned method (in any one of its different embodiments) when said program is executed on a computer.

Another embodiment of the invention proposes a computer-readable and non-transient storage medium storing a computer program comprising a set of instructions executable by a computer to implement the above-mentioned method (in any one of its different embodiments).

According to yet another aspect, the invention also pertains to an electronic terminal comprising means for generating at least one part of a virtual keypad on a touch screen of said terminal.

According to the invention, said means for generating comprise, in addition to the means for displaying said virtual keypad on said touch screen, means for computing a random graphic representation of said virtual keypad delivering at least one parameter representing a random zone of occupancy of said virtual keypad on said touch screen.

According to one particular characteristic of the invention, the electronic terminal consists of a payment terminal.

### LIST OF FIGURES

Other features and advantages of the invention shall appear more clearly from the following description of a particular embodiment, given by way of a simple illustratory and non-exhaustive example and from the appended drawings, of which:

FIGS. 1a to 1d illustrate examples of graphic representation of a virtual keyboard on a portable terminal according to at least one particular embodiment of the invention; embodiment of the invention;

FIG. 3 presents the structure of a terminal according to the invention.

### DESCRIPTION OF ONE EMBODIMENT OF THE INVENTION

5.1 General Principle

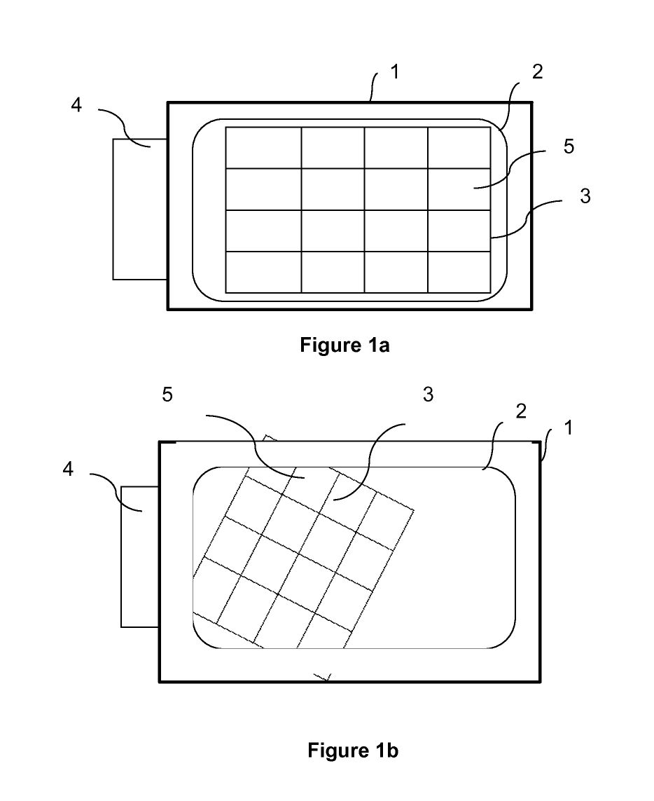

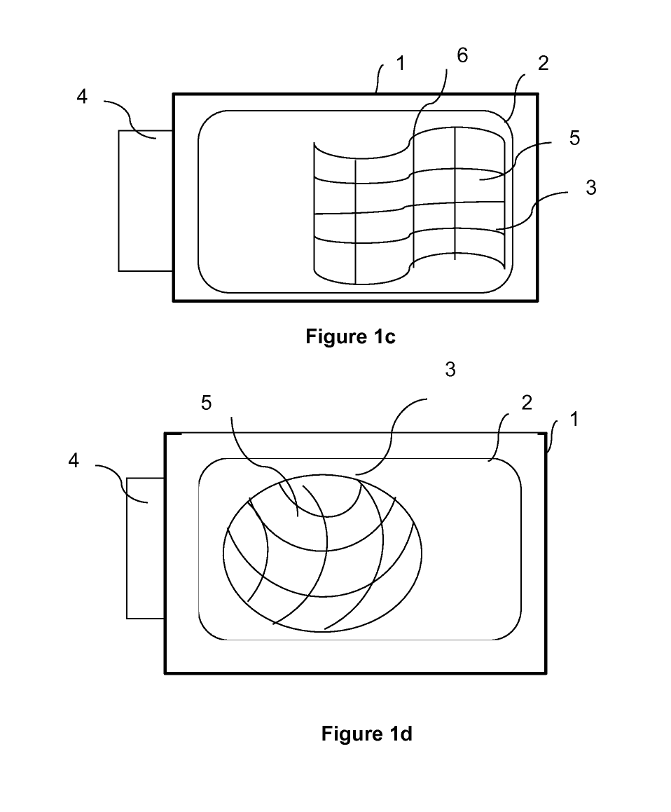

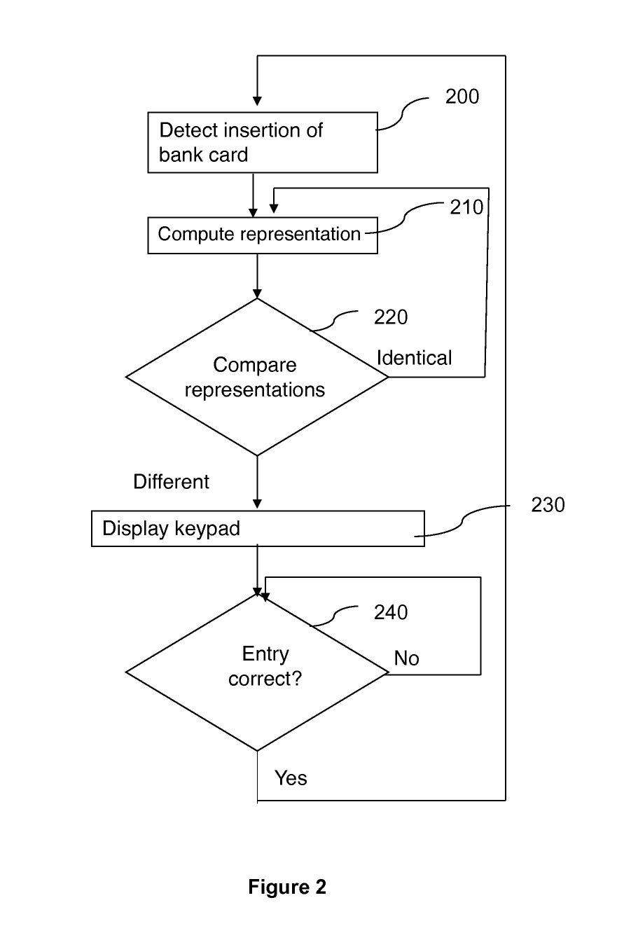

FIGS. 1a to 1d illustrate the general principle of the invention in one particular embodiment, implemented on a portable terminal 1 suited for the entry of a piece of sensitive data in the form of a series of alphanumeric characters, such as a confidential code, for example to make an electronic payment. This may be a terminal dedicated to payment, for example a payment terminal situated in a store, provided with means 4 for detecting and/or reading a bank card.

In other embodiments of the invention, the method can also be implemented on a Smartphone provided possibly with means for reading a bank card.

The general principle of the invention relies on the generation of a variable representation of a particular type of virtual keypad 3 on a portable terminal 1, for example a payment terminal, comprising a touch screen 2, the particular feature of this virtual keypad 2 being that it appears in different forms as and when the entries are made. FIGS. 1a to 1d illustrate the display of the virtual keypad for different entries of a confidential code, for example consecutive entries. As illustrated, the graphic representation of the virtual keypad differs as and when the entries are made. For example its location, its orientation, at least one of its dimensions and/or its shape are variable.

According to the invention, instead of classically occupying a same location of the touch screen 2, the virtual keypad 3 of the terminal 1 that is the object of the invention can, depending on the entries, has a variable orientation so as to encourage a user to make the terminal 1 pivot before entering a code, or it can occupy a different region of the touch screen (for example at the right-hand top and then at the left-hand bottom). In particular, it can be displayed with variable dimensions or it can be situated at a different location or again its contour and/or the contour of the keys that it represents can change shape, for example in having curved and non-rectilinear boundaries such as those of the prior-art digital pads. FIGS. 1c and 1d thus illustrate concave and/or convex changes in shape of the outline of the virtual keypad.

The representation of the virtual keypad can especially vary randomly between each entry.

Thus, a user who wishes to enter a particular code will activate a particular zone of the touch screen 2 which will vary if he repeats his entry. This variation will increase the traces on the touch screen 2. Furthermore, since the keys 5 of the virtual keypad 3 are situated, because of the change in shape and/or position of the keypad, at different positions of the screen at each entry, it will be impossible to relate a trace on the screen to any key of the keypad during an appearance, subsequent to the entry, of the keyboard.

In certain embodiments, the virtual keypad will preserve a constant sequencing of the keys so as not to disturb the user during his entry.

### Description of a Particular Embodiment

Referring now to FIG. 2, we present the method of the invention in one particular embodiment implemented for example in a portable terminal, for example the payment terminal illustrated in FIGS. 1a to 1d.

According to the invention, the method for generating a virtual keypad 3 on the touch screen 2 of the terminal comprises, prior to a step 230 for displaying the virtual keypad 3 on the touch screen 2, a step 210 for computing a random graphic representation of the virtual keypad 3.

In the embodiment illustrated, the method comprises first of all a step 200 for detecting and/or reading a bank card. In the embodiment presented, this detection is followed by the computation of a graphic representation of the virtual keypad to be displayed.

The step for computation 210 makes it possible especially to define the rendering parameters that are used to build the graphic representation of virtual keypad and especially its location, dimensions, its shape and its orientation on the touch screen.

In particular, the step for computing 210 can comprise a random generation of a plurality of numbers, which are then used to compute a percentage of occupancy of the touch screen by the virtual keypad 3 or a percentage of shape changing relative to a reference graphic representation of the virtual keypad 3, for example the last computed representation of the virtual keypad 3. Thus, one of the random numbers can enable the computation of a percentage of resizing of at least one of the dimensions of the virtual keypad 3. FIG. 1a especially illustrates the rendering of a virtual keypad 3 with the random generation of an increase in its width by a certain percentage, for example 38%.

The generation of a number in the interval [0; 360] can enable the computation in degrees of an orientation of the base of the keypad relative to the base of the screen 2. Thus, FIG. 1b illustrates the rendering of the keypad with the random generation of an orientation of about 60°.

In the embodiment illustrated in FIG. 1c, where the contours of the keypad have undergone concave and/or convex changes in shape, a first number can be used to compute the position of inversion 6 of the changes in shape, and second and third numbers can be used to compute the radius of curvature of the concave and convex changes in shape of the contours of each side of this point of inversion 6.

In the embodiment illustrated in FIG. 1d, the generation of a first random number makes it possible for example to determine the shape of the keypad from a plurality of n basic shapes (including a circle or a rectangle for example) by a “modulo n” computation and the generation of a second random number makes it possible to compute a change in shape to be applied to the basic shapes selected, for example longitudinally.

In certain particular embodiments, especially in the embodiment illustrated in FIG. 2, the step of computation 210 is followed by a step of comparison 220 of the graphic representation computed with at least one other graphic representation already obtained and memorized, so as to verify that the graphic representation generated has not already been used or at least that it does not correspond to one of the latest representations displayed. Thus, certain embodiments ensure that the location of the zone occupied by the keypad on the touch screen varies during two consecutive entries made on the touch screen.

When an identical graphic representation has already been generated previously, and stored, the computation step 210 is reiterated.

Besides, according to this embodiment, the graphic representation computed and displayed is memorized (step not shown) so that it can be compared, at a subsequent step 220, with a computed random graphic representation.

In the embodiment illustrated in FIG. 2, the comparison step 220 is followed by a display step 230 for displaying the virtual keypad 3 on the screen. In addition to the rendering of the keypad, the display step 230 can include a request to enter a confidential code for example. In certain embodiments, the method also comprises a step 240 for verifying the entry made. In certain embodiments, as in the embodiment illustrated, the representation of the keyboard remains unchanged so long as the entry is not correct, for a limited number of entries (classically three) or again until the bank card is removed. This embodiment has the advantage of offering a constant environment of entry, for a same entry operation, to a user during his numerous attempts at entry.

In other embodiments, the step for computing 210 and the steps following the step for computing can be reiterated at each entry attempt. Such an embodiment offers the advantage of further securing the entry of a code.

### Structure of a Portable Terminal According to the Invention

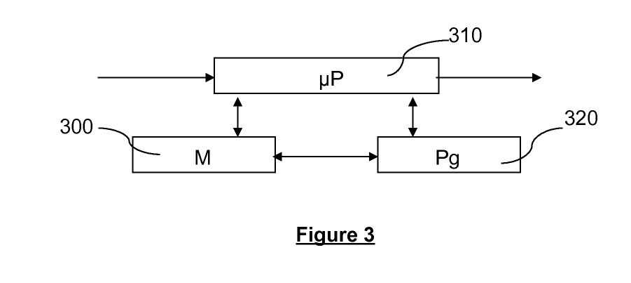

Referring to FIG. 3, the simplified structure of a portable terminal according to the invention is presented.

Such a terminal comprises a memory 300 comprising a buffer memory, a processing unit 310, equipped for example with a microprocessor μP, and driven by the computer program 320, the execution of which implements a method of generation, according to one of the particular embodiments of the invention. The terminal of the invention can also be provided with a touch screen. In the embodiment presented, it can furthermore be provided with a module suited to the insertion and reading of a bank card.

At initialization, the code instructions of the computer program 320 are for example loaded into a RAM and then executed by the processor of the processing unit 310.

The processing unit 310 receives inputs a notification of the insertion of a bank card into the module suited to the insertion and reading of a bank card.

The microprocessor of the processing unit 310 implements the steps of the method for generating described here above according to the instructions of the computer program 320.

To this end, the portable terminal comprises, in addition to the buffer memory 300, a module capable of generating at least a part of a virtual keyboard on a touch screen of said terminal.

According to the invention, the terminal also comprises, in addition to the display modules of said virtual keypad on said touch screen, modules for computing a random graphic representation of the virtual keypad delivering at least one parameter representing a random zone of occupancy of the keypad on the touch screen.

These modules are driven by the microprocessor of the processing unit 310.

According to one embodiment, the invention is implemented by means of software and/or hardware components. In this respect, the term “module” can correspond in this document both to a software component and to a hardware component or to a set of hardware and software components.

A software component corresponds to one or more computer programs, one or more sub-programs of a program or more generally to any element of a program or of a piece of software capable of implementing a function or a set of functions according to what has been described here below for the modules concerned.

In the same way, a hardware component corresponds to any element of a hardware set capable of implementing a function or a set of functions according to what is described here below for the module concerned. It may be a programmable hardware component or a component with an integrated processor for the execution of a piece of software, for example an integrated circuit, a smartcard, a memory card, an electronic card for the execution of a firmware program, etc.

An exemplary embodiment of the present disclosure provides a portable terminal comprising a touch screen that makes it possible to secure the entry of sensitive data by a user.

An embodiment provides a terminal such as this that is also ergonomic for the user.

An embodiment provides a terminal such as this that is low cost and easy to manufacture.

Although the present disclosure has been described with reference to one or more examples, workers skilled in the art will recognize that changes may be made in form and detail without departing from the scope of the disclosure and/or the appended claims.

1. A method for generating at least one part of a virtual keypad on a touch screen of an electronic terminal, wherein said method comprises:
prior to displaying said virtual keypad on said touch screen, computing, with a processor, a random graphic representation of said virtual keypad delivering at least one parameter representing a random zone of occupancy of said virtual keypad on said touch screen, wherein computing comprises memorizing said computed random graphic representation and comparing said computed random graphic representation with at least one previously memorized graphic representation; and
displaying said virtual keypad on said touch screen.

2. The method for generating according to claim 1, wherein computing takes account of at least one criterion of relative position of the alphanumeric keys of said random graphic representation of said virtual keypad.

3. The method for generating according to claim 2, wherein said criterion comprises keeping the relative position of at least one part of the alphanumeric keys of said random graphic representation unchanged between two successive displays of said virtual keypad.

4. The method for generating according to claim 2, wherein said criterion comprises modifying the relative position of at least one part of the alphanumeric keys of said random graphic representation between two successive displays of said virtual keyboard.

5. The method for generating according to claim 1, wherein said at least one parameter representing a random zone of occupancy of said virtual keypad on said touch screen belongs to the group consisting of:
a dimension of said virtual keypad;
a location of said virtual keypad on said screen;
a shape of the contours of said virtual keypad;
an orientation of said virtual keypad relative to said screen.

6. A non-transitory computer readable medium comprising a computer program product stored thereon and comprising program code instructions for implementing the a method for generating at least one part of a virtual keypad on a touch screen of an electronic terminal when said program is executed on a computer, wherein said method comprises:
prior to displaying said virtual keypad on said touch screen, computing, with a processor, a random graphic representation of said virtual keypad delivering at least one parameter representing a random zone of occupancy of said virtual keypad on said touch screen, wherein computing comprises memorizing said computed random graphic representation and comparing said computed random graphic representation with at least one previously memorized graphic representation; and
displaying said virtual keypad on said touch screen.

7. An electronic terminal comprising:
means for displaying at least one part of a virtual keypad on a touch screen of said terminal; and
means for computing a random graphic representation of said virtual keypad delivering at least one parameter representing a random zone of occupancy of said virtual keypad on said touch screen, said means for computing comprising means for memorizing said computed random graphic representation and means for comparing said computed random graphic representation with at least one previously memorized graphic representation.
